(19) United States
(12) Patent Application Publication
(10) Pub. No.: US 2021/0224926 A1
(43) Pub. Date: Jul. 22, 2021

(54) SERVER APPARATUS, CONTROL APPARATUS, MEDIUM, MOBILE SHOP, AND OPERATION METHOD FOR INFORMATION PROCESSING SYSTEM

(71) Applicant: TOYOTA JIDOSHA KABUSHIKI KAISHA, Toyota-shi (JP)

(72) Inventors: Ryosuke KOBAYASHI, Nagakute-shi (JP); Ayana TAKESHITA, Kasugai-shi (JP); Naoki YAMAMURO, Nagoya-shi (JP); Takuya MAEKAWA, Nagoya-shi (JP); Yugo SAKURAI, Setagaya-ku (JP)

(73) Assignee: TOYOTA JIDOSHA KABUSHIKI KAISHA, Toyota-shi (JP)

(21) Appl. No.: 17/140,235

(22) Filed: Jan. 4, 2021

(30) Foreign Application Priority Data
Jan. 21, 2020 (JP) 2020-007876

(51) Int. Cl. G06Q 50/00; G06Q 30/06; G06Q 20/12; G05D 1/00

(52) U.S. Cl. CPC G06Q 50/01; G06Q 30/0633; H04L 67/12; G05D 1/0011; G06Q 20/12

(57) ABSTRACT

A server apparatus includes a communication interface and a controller that transmits and receives information to and from other apparatuses via the communication interface. The controller transmits an instruction, to a mobile shop stocking wearable items, for moving to a point designated by a first terminal apparatus of a wearer. The controller receives a captured image of the wearer from the mobile shop and transmits the captured image to a second terminal apparatus of an evaluator. The controller receives evaluation information from the second terminal apparatus and transmits the evaluation information to the first terminal apparatus.

### CROSS-REFERENCE TO RELATED APPLICATION

This application claims priority to Japanese Patent Application No. 2020-7876 (filed on Jan. 21, 2020), the entire contents of which are incorporated herein by reference.

### TECHNICAL FIELD

The present disclosure relates to a server apparatus, a control apparatus, a medium, a mobile shop, and an operation method for an information processing system.

### BACKGROUND

Consumers considering whether to purchase a wearable item sometimes refer to evaluations by others, such as friends, after trying the wearable item on. Various techniques for supporting the acquisition of evaluations by others after trying on wearable items have been proposed. For example, patent literature (PLT) 1 discloses a virtual fitting evaluation system that combines an image of a wearer with an image of a wearable item to generate a try-on image and transmits the try-on image to another person.

### CITATION LIST

### Patent Literature

PTL 1: JP 2003-155617 A

### SUMMARY

Techniques for acquiring another person's evaluation of the result of trying a wearable item on could be made more efficient and more convenient for consumers.

It would be helpful to provide a server apparatus capable of more efficiently obtaining another person's evaluation of the result of trying a wearable item on.

A server apparatus according to the present disclosure includes a communication interface and a controller configured to transmit and receive information to and from other apparatuses via the communication interface. The controller transmits an instruction, to a mobile shop stocking wearable items, for moving to a point designated by a first terminal apparatus of a wearer. The controller receives a captured image of the wearer from the mobile shop and transmits the captured image to a second terminal apparatus of an evaluator. The controller receives evaluation information from the second terminal apparatus and transmits the evaluation information to the first terminal apparatus.

A control apparatus of a mobile shop according to the present disclosure is to be mounted in a mobile shop and is configured to transmit and receive information to and from a server apparatus and to control the mobile shop. The mobile shop includes an imager. The control apparatus receives an instruction from the server apparatus to move to a point designated by a first terminal apparatus of a wearer. The control apparatus transmits an image of the wearer captured by the imager to a second terminal apparatus of an evaluator and causes the second terminal apparatus to transmit evaluation information.

An operation method for an information processing system according to the present disclosure is an operation method for an information processing system including a server apparatus and a mobile shop. The mobile shop is configured to communicate with the server apparatus and includes an imager. The operation method includes transmitting, from the server apparatus to a mobile shop stocking wearable items, an instruction to move to a point designated by a first terminal apparatus of a wearer, transmitting a captured image of the wearer from the mobile shop to the server apparatus, and transmitting the captured image from the server apparatus to a second terminal apparatus of an evaluator, receiving evaluation information at the server apparatus from the second terminal apparatus, and transmitting the evaluation information from the server apparatus to the first terminal apparatus.

According to the server apparatus of the present disclosure, another person's evaluation of the result of trying a wearable item on can be obtained more efficiently.

### BRIEF DESCRIPTION OF THE DRAWINGS

In the accompanying drawings:

FIG. 1 illustrates an example configuration of an information processing system;

FIG. 2 illustrates an example configuration of a server apparatus;

FIG. 3 illustrates an example configuration of a terminal apparatus;

FIG. 4 illustrates an example configuration of a mobile shop;

FIG. 5 is a sequence diagram illustrating an operation example of the information processing system; and

FIG. 6 is a sequence diagram illustrating an operation example of the information processing system.

### DETAILED DESCRIPTION

Embodiments are described below.

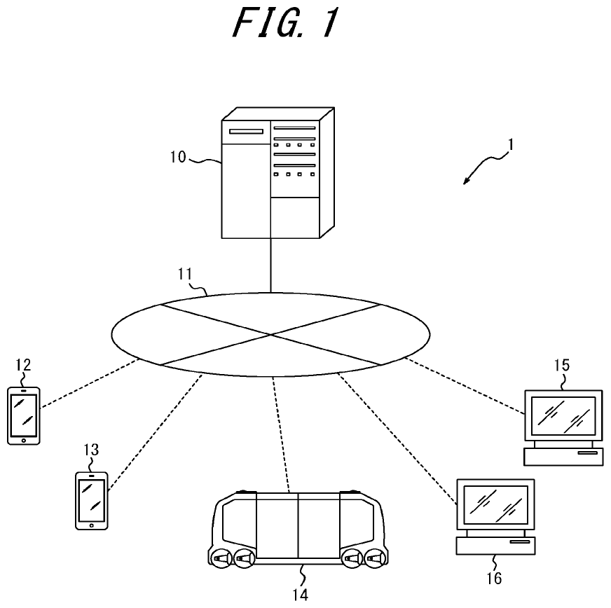

FIG. 1 illustrates an example configuration of an information processing system in an embodiment. The information processing system 1 includes, for example, a server apparatus 10, terminal apparatuses 12, 13, 15, 16 and a mobile shop 14 communicatively connected to each other via a network 11. The server apparatus 10 is a computer. The terminal apparatus 12, 13 are, for example, portable information terminal apparatuses such as smartphones or tablet terminal apparatuses but may also be personal computers. The terminal apparatus 15, 16 are, for example, information terminal apparatuses such as smartphones, tablet terminal apparatuses, or personal computers. The mobile shop 14 is a multi-purpose vehicle equipped with shop facilities and with control and communication functions. The network 11 is, for example, the Internet, but may include an ad hoc network, a LAN, a metropolitan area network (MAN), or other networks, or any combination thereof. The number of each component included in the information processing system 1 may be greater than the case illustrated here.

The information processing system 1 supports the trying on and purchasing of wearable items, such as clothing and accessories, by a consumer. An overview is now provided of how the information processing system 1 operates when a consumer tries on a wearable item that the consumer is thinking about purchasing and wants an evaluation, from a friend or other person, of the result of trying the wearable item on. The consumer trying on a wearable item is referred to below as the wearer, and the other person evaluating the result of trying the wearable item on is referred to as the evaluator. First, the server apparatus 10 receives information on wearable items sold at each shop from terminal apparatuses (shop terminal apparatuses) 15, 16 installed respectively in a plurality of different shops that sell wearable items, and then transmits the information on the wearable items of each shop to the terminal apparatus of the wearer (wearer terminal apparatus) 12. The wearer confirms the wearable item information and selects a requested wearable item with the wearer terminal apparatus 12. The server apparatus 10 receives the wearer's request from the wearer terminal apparatus 12 and transmits an instruction, to the mobile shop 14, to collect the wearable item and move to the location of the wearer terminal apparatus 12. After the mobile shop 14 arrives with the wearable item, the wearer enters the mobile shop 14 and tries on the desired wearable item. An imaging means provided in the mobile shop 14 then captures an image of the wearer with the wearable item on. The server apparatus 10 receives the captured image from the mobile shop 14 and transmits the captured image to the terminal apparatus (evaluator terminal apparatus) 13 of the evaluator. The evaluator views the captured image of the wearer and inputs an evaluation with the evaluator terminal apparatus 13. The server apparatus 10 receives evaluation information from the evaluator terminal apparatus 13 and transmits the evaluation information to the wearer terminal apparatus 12. The wearer can then confirm the evaluation with the wearer terminal apparatus 12 and refer to the evaluation to decide whether to purchase the wearable item that the wearer tried on.

The information processing system 1 enables the mobile shop 14 to collect the wearable items desired by the wearer from a plurality of shops, thereby saving the wearer the time and effort needed to visit the shops. The mobile shop 14 also transmits the captured image of the result of trying the wearable item on to the evaluator terminal apparatus 13, thereby enabling the wearer to obtain the evaluation of the evaluator easily and efficiently. Convenience for the wearer is therefore improved.

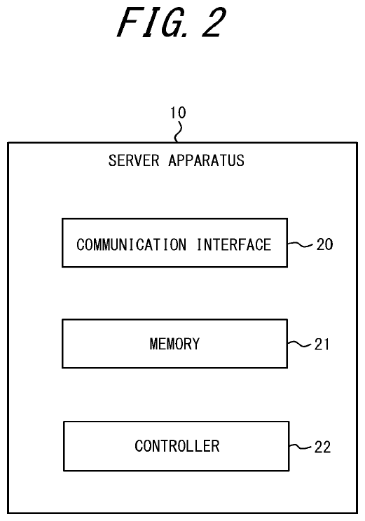

FIG. 2 illustrates an example configuration of the server apparatus 10. The server apparatus 10 includes a communication interface 20, a memory 21, and a controller 22. The server apparatus 10 may execute operations in the present embodiment by communicating and cooperating with another server apparatus having the same configuration.

The communication interface 20 includes a communication module compliant with one or more wired or wireless LAN standards for connecting to the network 11. In the present embodiment, the server apparatus 10 is connected to the network 11 via the communication interface 20 and communicates information with other apparatuses over the network 11.

The memory 21 includes, for example, a semiconductor memory, a magnetic memory, or an optical memory. The memory 21 functions as, for example, a main storage device, an auxiliary storage device, or a cache memory. The memory 21 stores any information, control and processing programs, and the like used in the operation of the server apparatus 10.

The controller 22 may include one or more general purpose processors, such as a central processing unit (CPU), or one or more dedicated processors specialized for a particular process. Alternatively, the controller 22 may include dedicated circuitry such as one or more field-programmable gate arrays (FPGAs) or application specific integrated circuits (ASICs). The controller 22 operates according to a control and processing program, or operates according to an operation procedure implemented as a circuit, to comprehensively control the operation of the server apparatus 10. The controller 22 transmits and receives various information to and from the wearer terminal apparatus 12, the evaluator terminal apparatus 13, the shop terminal apparatuses 15, 16, and the mobile shop 14 via the communication interface 20 and executes the operations according to the present embodiment.

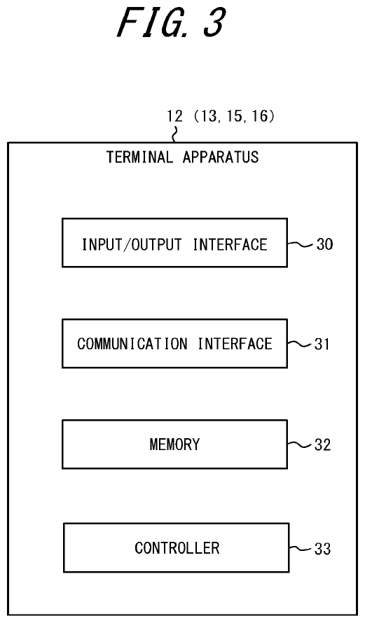

FIG. 3 illustrates an example configuration of the wearer terminal apparatus 12. The example configuration of the wearer terminal apparatus 12 illustrated here also applies to the evaluator terminal apparatus 13 and the shop terminal apparatuses 15, 16. The wearer terminal apparatus 12 is, for example, an information terminal apparatus such as a smartphone, tablet terminal apparatus, or personal computer. The wearer terminal apparatus 12 includes an input/output interface 30, a communication interface 31, a memory 32, and a controller 33.

The input/output interface 30 includes an input interface that detects user input and transmits the input information to the controller 33. The input interface may be any type of input interface, such as a physical key, a capacitance key, a touch screen integrally provided with a panel display, various pointing devices, a microphone for receiving audio input, or a camera for capturing images or image codes. The input/output interface 30 also has an output interface for outputting information generated by the controller 33 or received from another apparatus to the user. Such an output interface may be any type of output interface, such as an external or built-in display for outputting information as an image or video, a speaker for outputting information as audio, or an interface for connection with an external output device.

The communication interface 31 includes a communication module compliant with a wired or wireless LAN standard, a module compliant with a mobile object communication standard such as the 4^{th} Generation (4G) standard or the 5^{th} Generation (5G) standard, or the like. The wearer terminal apparatus 12 is connected by the communication interface 31 to the network 11 via a nearby router or a base station for mobile object communication and communicates information with other apparatuses over the network 11.

The memory 32 includes, for example, a semiconductor memory, a magnetic memory, or an optical memory. The memory 32 functions as, for example, a main storage device, an auxiliary storage device, or a cache memory. The memory 32 stores any information, control and processing programs, and the like used in the operation of the wearer terminal apparatus 12. In the case of the shop terminal apparatuses 15, 16, the memory 32 stores wearable item information indicating the lineup of wearable items sold by the shop in which the shop terminal apparatus 15 or 16 is installed. For each wearable item, the wearable item information includes a product ID, a shop ID that specifies the shop at which the wearable item is sold, an image of the wearable item, wearable item attributes such as size, and the price of the wearable item.

The controller 33 may, for example, include one or more general purpose processors such as CPUs or micro processing unit (MPUs), or one or more dedicated processors specialized for a particular process. Alternatively, the controller 33 may include dedicated circuitry, such as one or more FPGAs or ASICs. The controller 33 operates according to a control and processing program, or operates according to an operation procedure implemented as circuitry, to comprehensively control the operation of the wearer terminal apparatus 12. The controller 33 then transmits and receives various types of information to and from the server apparatus 10 and the like via the communication interface 31 and executes the operations according to the present embodiment.

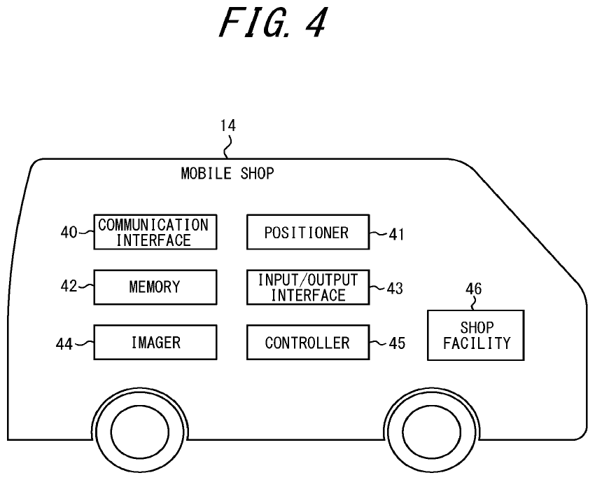

FIG. 4 illustrates an example configuration of the mobile shop 14. The mobile shop 14 is a multi-purpose vehicle in which equipment for a particular purpose can be loaded to the vehicle interior space. In the present embodiment, the mobile shop 14 is configured to have a shop facility 46 mounted therein for selling wearable items. The shop facility 46 stocks the wearable items collected at wearable item shops and includes an internal space into which the wearer can enter from outside the mobile shop 14 and try on wearable items. This shop facility 46 may be managed and operated by a salesperson onboard the mobile shop 14 or may be left unattended.

The mobile shop 14 further includes a communication interface 40, a positioner 41, a memory 42, an input/output interface 43, an imager 44, and a controller 45. The components are communicably connected to each other in a wired or wireless manner via an on-board network, such as a controller area network (CAN), or a dedicated line, for example. Some or all of the communication interface 40, positioner 41, memory 42, input/output interface 43, imager 44, and controller 45 may be provided directly in the mobile shop 14 or may be provided in a control apparatus that is detachable from the mobile shop 14, such as a car navigation apparatus. The mobile shop 14 may be driven by a driver, or driving may be automated at any level. The level of automation is, for example, one of level 1 to level 5 in the level classification of the Society of Automotive Engineers (SAE).

The communication interface 40 includes a communication module compliant with a wired or wireless LAN standard, a module compliant with a mobile object communication standard such as 4G or 5G, or the like. The mobile shop 14 is connected to the network 11 by the communication interface 40 via a base station for mobile object communication and communicates information with other devices over the network 11.

The positioner 41 measures the position of the mobile shop 14 and generates position information. The position information is information including coordinates, such as two-dimensional coordinates or three-dimensional coordinates, that identify a position on a map. The position information is not limited to coordinates and may include the speed, patrol route, or travel distance, the amount or rate of change thereof, or the like. The positioner 41 includes a receiver corresponding to a satellite positioning system. The satellite positioning system to which the receiver corresponds may, for example, be a global positioning system (GPS). Alternatively, the positioner 41 may include an accelerometer, a gyroscopic sensor, or the like. A car navigation apparatus, for example, may function as the positioner 41.

The memory 42 includes, for example, a semiconductor memory, a magnetic memory, or an optical memory. The memory 42 functions as, for example, a main storage device, an auxiliary storage device, or a cache memory. The memory 42 stores any information, control and processing programs, and the like used for controlling the operation of the mobile shop 14.

The input/output interface 43 includes an input interface that detects user input and transmits the input information to the controller 45. The input interface may be any type of input interface, such as a physical key, a capacitance key, a touch screen integrally provided with a panel display, various pointing devices, a microphone for receiving audio input, a camera for capturing images or image codes, an IC card reader, or the like. The input/output interface 43 also includes an output interface that outputs information, generated by the controller 45 or received from the server apparatus 10, to the user. The output interface may be any type of output interface, such as a display for outputting information as an image or video, a speaker for outputting information as audio, or an interface for connecting with an external output device.

The imager 44 includes one or more cameras and a corresponding control circuit. The cameras are disposed at a position enabling the capturing of an image of the wearer who has tried on a wearable item in the shop facility 46. Each camera included in the imager 44 may be a monocular camera or a stereo camera.

The controller 45 may include one or more general purpose processors, such as CPUs or MPUs, or one or more dedicated processors specialized for a particular process. Alternatively, the controller 45 may include dedicated circuitry, such as one or more FPGAs or ASICs. The controller 45 operates according to a control and processing program, or operates according to an operation procedure implemented as circuitry, to comprehensively control the operation of the mobile shop 14, including the communication interface 40, positioner 41, memory 42, input/output interface 43, imager 44, and shop facility 46. When the mobile shop 14 is driven automatically, the controller 45 transmits the information required for the operation of the mobile shop 14 to a control apparatus that controls automatic driving. The controller 45 transmits and receives various information to and from the server apparatus 10 through the communication interface 40 and executes the operations according to the present embodiment.

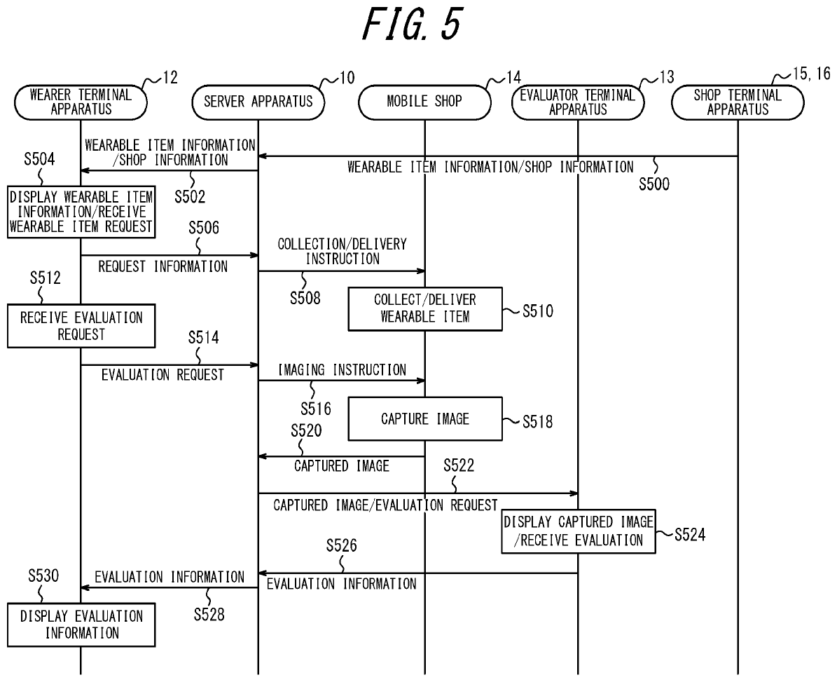

FIG. 5 is a sequence diagram illustrating an operation example of the information processing system 1. FIG. 5 illustrates operation procedures for cooperative operation by the server apparatus 10, the wearer terminal apparatus 12, the evaluator terminal apparatus 13, the shop terminal apparatuses 15, 16, and the mobile shop 14. The procedures of FIG. 5 are procedures for the information processing system 1 to support the acquisition of an evaluation, from the evaluator, of the wearer who tries on a wearable item.

In step S500, the controller 33 of each of the shop terminal apparatuses 15, 16 transmits wearable item information indicating the lineup of wearable items in the corresponding shop and shop information indicating the location of the corresponding shop to the server apparatus 10 via the communication interface 31. For example, the controller 33 outputs wearable item information stored in the memory 32 via the input/output interface 30, selects/processes wearable item information in accordance with input from a clerk to the input/output interface 30, and transmits the wearable item information together with shop information stored in the memory 32 to the server apparatus 10. The controller 22 of the server apparatus 10 then receives the wearable item information and the shop information via the communication interface 20. Step S500 is executed at any appropriate timing. For example, step S500 may be executed at predetermined intervals, such as daily or weekly, or each time a wearable item is purchased by the wearer.

In step S502, the controller 22 of the server apparatus 10 transmits the wearable item information received from the shop terminal apparatuses 15, 16 to the wearer terminal apparatus 12 via the communication interface 20. The controller 33 of the wearer terminal apparatus 12 then receives the wearable item information via the communication interface 31.

In step S504, the controller 33 of the wearer terminal apparatus 12 outputs the wearable item information via the input/output interface 43 and receives a wearable item request from the wearer via the input/output interface 43. In step S506, the controller 33 then transmits request information indicating the wearable item requested by the wearer, the shop that sells the wearable item, and the location of the wearer to the server apparatus 10 via the communication interface 31. In other words, the controller 33 transmits information designating a wearable item for the mobile shop to collect to the server apparatus 10 via the communication interface 31. The controller 22 of the server apparatus 10 then receives the request information via the communication interface 20. For example, the wearer uses the wearer terminal apparatus 12 to access a portal site of a wearable item sales service provided by the server apparatus 10, views wearable item information, and provides input to select desired wearable items. The wearer also inputs the wearer's location to the portal site. The wearer may input information indicating the wearer's location once during member registration, for example, or each time the wearer requests a wearable item. The server apparatus 10 thus receives request information from the wearer terminal apparatus 12.

In step S508, the controller 22 of the server apparatus 10 transmits a collection/delivery instruction to the mobile shop 14 via the communication interface 20 in accordance with the request information so that the wearable items requested by the wearer are collected from the shops of the shop terminal apparatuses 15, 16 and delivered to the wearer. The controller 45 of the mobile shop 14 then receives the collection/delivery instruction via the communication interface 40. Information indicating the requested wearable item, the shop that sells the wearable item, and the location of the wearer is included in the collection/delivery instruction. An instruction for the mobile shop to collect wearable items from a plurality of shops may be included in the collection/delivery instruction.

In step S510, the controller 45 of the mobile shop 14 controls the mobile shop 14, in accordance with the collection instruction, to collect the wearable items and deliver them to the location of the wearer. For example, the controller 45 may output the wearable item to collect, the position of the shops selling the wearable items, and the location of the wearer using a display of the input/output interface 43 to instruct a crew member of the mobile shop 14 to visit the shops, collect the wearable items, and deliver the collected wearable items to the point designated by the wearer terminal apparatus 12, i.e. the location of the wearer. The controller 45 may also cause the mobile shop 14 to move by transmitting an instruction to an automatic driving control apparatus of the mobile shop 14 for the mobile shop 14 to visit shops and then head to the location of the wearer. At each shop, a shop clerk or a crew member of the mobile shop 14 manually loads the wearable items into the shop facility 46 of the mobile shop 14. Alternatively, the wearable items may be loaded into the mobile shop 14 by an automatic machine installed in the mobile shop 14 or in each shop. After the mobile shop 14 arrives at the location of the wearer, the wearer enters the shop facility 46 and tries on the desired wearable items that were delivered. The controller 45 of the mobile shop 14 may transmit an arrival notification to the wearer terminal apparatus 12 via the communication interface 40 either directly or by way of the server apparatus 10. The wearer can thus learn of the arrival of the mobile shop 14.

When the wearer tries on a wearable item and needs an evaluation, from the evaluator, of the result of trying the wearable item on, the wearer operates the wearer terminal apparatus 12 to input an evaluation request. In step S512, the controller 33 of the wearer terminal apparatus 12 receives the evaluation request from the wearer via the input/output interface 43. Information designating the evaluator is included in the evaluation request. In step S514, the controller 33 then transmits the evaluation request to the server apparatus 10 via the communication interface 31. The controller 22 of the server apparatus 10 then receives the evaluation request via the communication interface 20. In response to operation by the wearer, the wearer terminal apparatus 12 may launch a try-on evaluation application that cooperates with the server apparatus 10 and receives input from the wearer, for example. The wearer terminal apparatus 12 presents the wearer, via the application, with information on evaluators that can be designated. The wearer may, for example, register information of friends or the like in advance as evaluator information in association with the wearer's account in the application. Evaluator information on evaluators that can be designated is thus stored in the server apparatus 10. The wearer terminal apparatus 12 receives the evaluator information from the server apparatus 10 and presents the wearer with evaluators that can be designated. When the wearer selects and designates a desired evaluator, information indicating the designated evaluator is transmitted to the server apparatus 10. The evaluation request is thus transmitted to the server apparatus 10. In other words, the evaluator terminal apparatus 13 is designated by information received from the wearer terminal apparatus 12.

In step S516, the controller 22 of the server apparatus 10 transmits an imaging instruction, to capture an image of the result of the wearer trying on the wearable item, to the mobile shop 14 via the communication interface 20 in response to the evaluation request. The controller 45 of the mobile shop 14 then receives the imaging instruction via the communication interface 40.

Instead of the wearer terminal apparatus 12 transmitting the imaging instruction to the mobile shop 14 via the server apparatus 10 in steps S514 and S516, the wearer terminal apparatus 12 may transmit the imaging instruction directly to the mobile shop 14 without going through the server apparatus 10.

In step S518, the controller 45 of the mobile shop 14 controls the imager 44 to capture an image of the wearer inside the shop facility 46.

In step S520, the controller 45 of the mobile shop 14 transmits the captured image to the server apparatus 10 via the communication interface 40. The controller 22 of the server apparatus 10 then receives the captured image via the communication interface 20.

In step S522, the controller 22 of the server apparatus 10 transmits the captured image received from the mobile shop 14 together with the evaluation request that requests an evaluation of the result of trying the wearable item on to the evaluator terminal apparatus 13 via the communication interface 20. Based on the evaluation request received from the wearer terminal apparatus 12 in step S514, the controller 22 at this time identifies the evaluator terminal apparatus 13 to which the captured image is to be transmitted. For example, the controller 22 identifies information of the evaluator terminal apparatus 13 corresponding to the designated evaluator from the evaluator information registered in the memory 21 of the server apparatus 10 and transmits the captured image and the evaluation request to that evaluator terminal apparatus 13. The controller 33 of the evaluator terminal apparatus 13 then receives the captured image and the evaluation request via the communication interface 31.

In a modification to step S522, the controller 22 processes the captured image in accordance with the evaluator terminal apparatus 13 to which the captured image is to be transmitted. For example, when designating the evaluator in step S514, the wearer can operate the wearer terminal apparatus 12 to instruct the controller 22 of the server apparatus 10 to make the result of trying on the wearable item anonymous when presented to the evaluator. The controller 22 may perform image processing in accordance with this instruction to blur or pixelate the wearer's face in the captured image so that the wearer is unidentifiable. This enables the wearer to request an evaluation from the evaluator while maintaining privacy.

Via the input/output interface 43, the controller 33 of the evaluator terminal apparatus 13 outputs the captured image of the result of trying on the wearable item and receives input of the evaluator's evaluation of the result of trying on the wearable item in step S524. The evaluation is inputted to the evaluator terminal apparatus 13 by the evaluator selecting an evaluation score from among a range of scores or inputting a freely-chosen evaluation score, for example. The evaluation may instead be text representing any comment. In step S526, the controller 33 then transmits evaluation information indicating the evaluation to the server apparatus 10 via the communication interface 31. The controller 22 of the server apparatus 10 then receives the evaluation information via the communication interface 20. In response to operation by the evaluator, the evaluator terminal apparatus 13 may launch a try-on evaluation application that cooperates with the server apparatus 10 and outputs the captured image of the result of the wearer trying on the wearable item, for example. The evaluator terminal apparatus 13 then receives input of the evaluation via the application and transmits the evaluation result to the server apparatus 10.

In step S528, the controller 22 of the server apparatus 10 transmits the evaluation information to the wearer terminal apparatus 12 via the communication interface 20. The controller 33 of the wearer terminal apparatus 12 then receives the evaluation information via the communication interface 31.

In step S530, the controller 33 of the evaluator terminal apparatus 13 outputs the evaluation information via the input/output interface 43. For example, the controller 33 displays the evaluation of the evaluator, indicated by the evaluation information, via the display of the input/output interface 43. This enables the wearer to obtain the evaluation of the evaluator for the result of the wearer trying on the wearable item and to refer to the evaluation when deciding whether to purchase the wearable item.

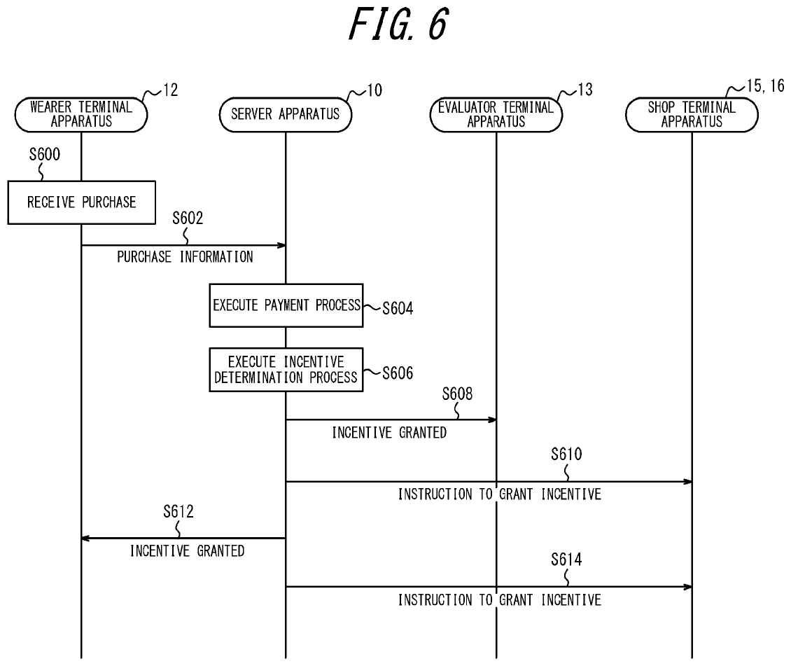

FIG. 6 is a sequence diagram illustrating another operation example of the information processing system 1. FIG. 6 illustrates operation procedures for cooperative operation by the server apparatus 10, the wearer terminal apparatus 12, the evaluator terminal apparatus 13, and the shop terminal apparatuses 15, 16. The procedures of FIG. 6 are procedures for the information processing system 1 to support a wearable item purchase by the wearer and the accompanying granting of an incentive. The procedures of FIG. 6 are executed when the wearer who referred to the evaluation from the evaluator by the procedures of FIG. 5 purchases the wearable item that the wearer tried on.

In step S600, the controller 33 of the wearer terminal apparatus 12 receives a request to purchase a wearable item from the wearer via the input/output interface 30. In step S602, the controller 33 then transmits purchase information corresponding to input from the wearer to the server apparatus 10 via the communication interface 31. The purchase information includes the product ID of the wearable item the wearer intends to purchase, the shop ID, an image, size or other attributes, cost, and information on a financial account of the purchaser. The controller 22 of the server apparatus 10 then receives the purchase information via the communication interface 20. For example, the wearer uses the wearer terminal apparatus 12 to access a portal site of a wearable item sales service provided by the server apparatus 10 and provides input to select the wearable item the wearer has tried on and wishes to purchase. The wearer also inputs information necessary for payment, such as the wearer's credit card number or financial account, on the portal site. The wearer may input information necessary for payment once during member registration, for example. In this way, the server apparatus 10 receives the purchase information from the wearer terminal apparatus 12.

In step S604, the controller 22 of the server apparatus 10 performs a payment process for the purchase price of the wearable item in accordance with the purchase information. The controller 22 performs a process to charge the purchaser based on the financial account information of the wearer included in the purchase information. For example, the controller 22 charges the purchaser by transmitting a charging process request to another server apparatus that manages the financial account of the wearer. The charging process includes any electronic payment means, such as a money transfer between accounts, credit card payment, or a transfer of virtual currency. The controller 22 also transmits a money transfer request to a server apparatus of a financial institution for transferring the cost of the sale to the financial account of the shop.

In step S606, the controller 22 of the server apparatus 10 performs a process to determine the granting of an incentive to either or both of the evaluator and the wearer. The incentive has economic value during the purchase of wearable items in the shop and may, for example, be points, a coupon, virtual currency, actual currency, or the like.

When the wearer receives an evaluation from the evaluator and purchases a wearable item, the evaluator can be considered to have supported the sale of wearable items by the shop. In this case, the controller 22 of the server apparatus 10 therefore performs a process to determine the granting of an incentive to the evaluator. The size of the incentive may be a value that has any positive correlation with the price of the purchased wearable item, a predetermined value, or the like. The controller 22 transmits information indicating the incentive to the evaluator terminal apparatus 13 in step S608 and instructs the shop terminal apparatus 15 or 16 of the shop selling the purchased wearable item to grant the incentive to the evaluator in step S610. The shop terminal apparatus 15 or 16 includes, in advance, member information identifying the evaluator, for example, and grants the incentive to the member account of the evaluator in response to the instruction from the server apparatus 10.

When the wearer has received a predetermined number or greater of positive evaluations from the evaluator, the wearer can be considered to have supported the sale of wearable items by the shop indirectly by spreading the word about the appeal of the wearable item the wearer tried on. Accordingly, the controller 22 of the server apparatus 10 stores a history of evaluations for the wearer in the memory 21 and determines to grant an incentive to the wearer when an evaluation of any appropriate reference score or higher is obtained or when any appropriate number or greater of positive comments, as yielded by any text analysis algorithm, is obtained. For example, the controller 22 transmits information indicating the incentive to the wearer terminal apparatus 12 in step S612 and instructs the shop terminal apparatus 15 or 16 of the shop selling the purchased wearable item to grant the incentive to the wearer in step S614. The shop terminal apparatus 15 or 16 includes, in advance, member information identifying the wearer, for example, and grants the incentive to the member account of the wearer in response to the instruction from the server apparatus 10.

As described above, the present embodiment saves the wearer the time and effort needed to visit a shop and saves the wearer the trouble of capturing an image of the result of trying on a wearable item and transmitting the captured image to an evaluator. The wearer can thereby more efficiently obtain another person's evaluation of the result of trying on the wearable item. The sale of wearable items in a shop when the wearer acquires an evaluation of the result of trying on a wearable item can also be encouraged by the granting of an incentive in the above-described way.

An example in which wearable items are collected from two shops to contribute to the convenience of the wearer has been described, but the number of shops is not limited to two. All cases of collecting a wearable item from one or more shops are included in the present embodiment.

In the above embodiment, a processing/control program that specifies operations of the controller 33 of the wearer terminal apparatus 12 and the shop terminal apparatuses 15, 16 may be stored in the memory 21 of the server apparatus 10 or in the memory of another server apparatus and be downloaded onto each terminal apparatus via the network 11. The processing/control program may also be stored on a non-transitory portable recording/storage medium readable by each terminal apparatus, and each terminal apparatus may read the program from the medium. A processing/control program that specifies operations of the controller 45 of the mobile shop 14 may be stored in the memory 21 of the server apparatus 10 or in the memory of another server apparatus and be downloaded onto the mobile shop 14 via the network 11. The processing/control program may also be stored on a non-transitory portable recording/storage medium readable by the controller 45, and the controller 45 may read the program from the medium.

Although embodiments have been described on the basis of drawings and examples, it is to be noted that various changes and modifications may be implemented by those skilled in the art based on the present disclosure. Therefore, such changes and modifications are to be understood as included within the scope of the present disclosure. For example, the functions and the like included in the various means and steps may be reordered in any logically consistent way. Furthermore, means and steps may be combined into one or divided.

1. A server apparatus comprising:
a communication interface; and
a controller configured to transmit and receive information to and from other apparatuses via the communication interface;
wherein the controller is configured to transmit an instruction, to a mobile shop stocking wearable items, for moving to a point designated by a first terminal apparatus of a wearer, to receive a captured image of the wearer from the mobile shop and transmit the captured image to a second terminal apparatus of an evaluator, and to receive evaluation information from the second terminal apparatus and transmit the evaluation information to the first terminal apparatus.

2. The server apparatus of claim 1, wherein the controller is configured to receive information designating a wearable item to be collected by the mobile shop and to transmit an instruction to collect the wearable item to the mobile shop.

3. The server apparatus of claim 1, wherein the second terminal apparatus is designated by information received from the first terminal apparatus.

4. The server apparatus of claim 3, wherein the controller is configured to process the captured image in accordance with the information received from the first terminal apparatus.

5. The server apparatus of claim 1, wherein the controller is configured to receive a request from the first terminal apparatus to make a payment related to purchasing a wearable item and to process the payment.

6. The server apparatus of claim 5, wherein the controller is configured to determine an incentive corresponding to the second terminal apparatus when processing the payment.

7. The server apparatus of claim 5, wherein the controller is configured to determine an incentive corresponding to the first terminal apparatus in accordance with the evaluation information.

8. An information processing system comprising the server apparatus of claim 1 and the mobile shop.

9. A control apparatus to be mounted in a mobile shop that comprises an imager and configured to transmit and receive information to and from a server apparatus and to control the mobile shop,
wherein the control apparatus is configured to receive an instruction from the server apparatus to move to a point designated by a first terminal apparatus of a wearer, and
wherein the control apparatus is configured to transmit an image of the wearer captured by the imager to a second terminal apparatus of an evaluator and cause the second terminal apparatus to transmit evaluation information.

10. A non-transitory computer readable medium storing a program which, when executed by a computer, causes the computer to operate as the control apparatus of claim 9.

11. A mobile shop comprising the control apparatus of claim 9.

12. A non-transitory computer readable medium storing a program which, when executed by a computer capable of input and output of information, causes the computer to operate as the first terminal apparatus or the second terminal apparatus and communicate with the server apparatus of claim 1.

13. An operation method for an information processing system comprising a server apparatus and a mobile shop, the mobile shop being configured to communicate with the server apparatus and comprising an imager, the operation method comprising:
transmitting, from the server apparatus to a mobile shop stocking wearable items, an instruction to move to a point designated by a first terminal apparatus of a wearer;
transmitting a captured image of the wearer from the mobile shop to the server apparatus; and
transmitting the captured image from the server apparatus to a second terminal apparatus of an evaluator, receiving evaluation information at the server apparatus from the second terminal apparatus, and transmitting the evaluation information from the server apparatus to the first terminal apparatus.

14. The operation method of claim 13, further comprising:
receiving, at the server apparatus, information that designates a wearable item for the mobile shop to collect; and
transmitting, from the server apparatus to the mobile shop, an instruction to collect the wearable item.

15. The operation method of claim 13, wherein the second terminal apparatus is designated by information received from the first terminal apparatus.

16. The operation method of claim 15, further comprising processing, by the server apparatus, the captured image in accordance with the information received from the first terminal apparatus.

17. The operation method of claim 13, further comprising:
receiving, at the server apparatus, a request from the first terminal apparatus to make a payment related to purchasing a wearable item; and
processing the payment by the server apparatus.

18. The operation method of claim 17, further comprising determining, by the server apparatus, an incentive for the evaluator corresponding to the second terminal apparatus when the server apparatus processes the payment.

19. The operation method of claim 17, further comprising determining, by the server apparatus, an incentive for the wearer corresponding to the first terminal apparatus in accordance with the evaluation information.

20. The operation method of claim 13, further comprising collecting, by the mobile shop, a wearable item and moving, by the mobile shop, to the point designated by the first terminal apparatus in response to the instruction from the server apparatus.
